(19) United States
(12) Patent Application Publication
(10) Pub. No.: US 2024/0303141 A1
(43) Pub. Date: Sep. 12, 2024

(54) Application Resource Tracking Between Load Cycles of an Application

(71) Applicant: MICRO FOCUS LLC, SANTA CLARA, CA (US)

(72) Inventors: Douglas Max Grover, Rigby, ID (US); Michael F. Angelo, Houston, TX (US)

(73) Assignee: MICRO FOCUS LLC, SANTA CLARA, CA (US)

(21) Appl. No.: 18/182,241

(22) Filed: Mar. 10, 2023

(51) Int. Cl. G06F 11/07

(52) U.S. Cl. CPC G06F 11/0706; G06F 11/0793

(57) ABSTRACT

A first load cycle of an application is determined to have been completed. A load cycle is where the application has been loaded, executed, and then unloaded. One or more of first load parameter associated with the first load cycle of the application, a first execution parameter associated with the first load cycle of the application, and a first unload parameter associated with the first load cycle of the application are retrieved and compared to one or more of a second load parameter associated with a second load cycle of the application, a second execution parameter associated with the second load cycle of the application, and a second unload parameter associated with the second load cycle of the application. The comparison can then be used to identify anomalies between load cycles of the application.

### FIELD

The disclosure relates generally to resource tracking of anomalies and particularly to detecting anomalies in an application between load cycles of the application.

### BACKGROUND

Being able to identify anomalies and when they occur is an ongoing problem. Existing systems may be able to identify that an anomaly may have occurred; however, because the specific types of information necessary to identify the problem are not always available or stored in separate records, sometimes it takes a long time to identify the actual problem.

### SUMMARY

These and other needs are addressed by the various embodiments and configurations of the present disclosure. The present disclosure can provide a number of advantages depending on the particular configuration. These and other advantages will be apparent from the disclosure contained herein.

A first load cycle of an application is determined to have been completed. A load cycle is where the application has been loaded, executed, and then unloaded. One or more of first load parameter associated with the first load cycle of the application, a first execution parameter associated with the first load cycle of the application, and a first unload parameter associated with the first load cycle of the application are retrieved and compared to one or more of a second load parameter associated with a second load cycle of the application, a second execution parameter associated with the second load cycle of the application, and a second unload parameter associated with the second load cycle of the application. The comparison can then be used to identify anomalies between load cycles of the application.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “blockchain” as described herein and in the claims refers to a growing list of records, called blocks, which are linked using cryptography. The blockchain is commonly a decentralized, distributed and public digital ledger that is used to record transactions across many computers so that the record cannot be altered retroactively without the alteration of all subsequent blocks and the consensus of the network. Each block contains a cryptographic hash of the previous block, a timestamp, and transaction data (generally represented as a Merkle tree root hash). For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. In verifying or validating a block in the blockchain, a hashcash algorithm generally requires the following parameters: a service string, a nonce, and a counter. The service string can be encoded in the block header data structure, and include a version field, the hash of the previous block, the root hash of the Merkle tree of all transactions (or information or data) in the block, the current time, and the difficulty level. The nonce can be stored in an extraNonce field, which is stored as the left most leaf node in the Merkle tree. The counter parameter is often small at 32-bits so each time it wraps the extraNonce field must be incremented (or otherwise changed) to avoid repeating work. When validating or verifying a block, the hashcash algorithm repeatedly hashes the block header while incrementing the counter & extraNonce fields. Incrementing the extraNonce field entails recomputing the merkle tree, as the transaction or other information is the left most leaf node. The body of the block contains the transactions or other information. These are hashed only indirectly through the Merkle root.

As discussed herein and in the claims, the term “application” can be any type of executable software, such as, a software application, a firmware application, an executable, a script, a container, a virtual machine, a micro service, and/or the like.

As discussed herein and in the claims, the term “hash” may include a checksum.

As discussed herein and in the claims, the term “load cycle” comprises a load, execute, and unload of an application.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for tracking resources between load cycles of an application using a database.

FIG. 2 is a block diagram of a second illustrative system for tracking resources between load cycles of an application using a distributed ledger/blockchain.

FIG. 3 is a flow diagram of a process for tracking resources between load cycles of an application.

FIG. 4 is diagram of an exemplary blockchain that is used to track resources between load cycles of an application.

FIG. 5 is a diagram of an exemplary star blockchain that is used to track resources between load cycles of an application.

FIG. 6 is a diagram of an options window that is used to take an action based on an anomalous behavior.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

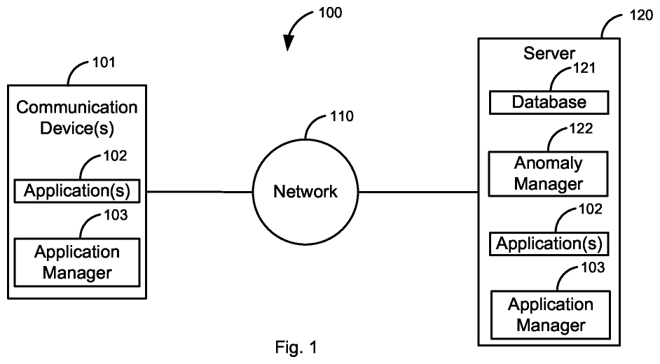

FIG. 1 is a block diagram of a first illustrative system 100 for tracking resources between load cycles of an application 102 using a database 121. The first illustrative system 100 comprises one or more communication devices 101, a network 110, and a server 120.

The communication device 101 can be or may include any device that can communicate on the network 110, such as a Personal Computer (PC), a telephone, a video system, a cellular telephone, a Personal Digital Assistant (PDA), a tablet device, a notebook device, a smartphone, an embedded device, a sensor, a server 120 (e.g., an application server), a communication device, and/or the like. As shown in FIG. 1, any number of communication devices 101 may be connected to the network 110, including only a single communication device 101.

The communication device(s) 101 further comprises one or more applications 102 and an application manager 103. The applications(s) 102 may be any type of application 102, such as, a financial application, a security application, a social network application, a web application, a word processing application, a spreadsheet application, a browser, an email application, a video application, a telephony application, an embedded application, a database application, a communication application, and/or the like.

The application manager 103 can be any software/firmware coupled with hardware that can identify load parameters, execution parameters, and/or unload parameters associated with the application 102. The application manager 103 may be distributed across the network 110. For example, the application manager 103 may comprise one or more protocol analyzers that capture and analyze packets on the network 110. In one embodiment, the application manager 103 may comprise multiple application managers 103. For example, each application 102 may have its own application manager 103. The application manager 103 collects parameters associated with the application 102 and sends them to the anomaly manager 122 for analysis.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The server 120 may be any hardware coupled with software that can be used for anomaly management, such as, a network management server, a communication device 101, and/or the like. The server 120 further comprises a database 121, an anomaly manager 122, application(s) 102, and an application manager 103.

The database 121 may be any type of database 121 that can be used to store information, such as, a relational database, an objected oriented database, a hierarchical database, a NoSQL database, a graph database, a distributed database, a centralized database, a file system (e.g., stored in one or more files), and/or the like. The database 121 is used to store load, execute, and/or unload parameters associated with a load cycle of the application(s) 102.

The anomaly manager 122 can be or may include any software/firmware combined with hardware that can be used to potentially identify anomalous behavior of the application(s) 102. The anomaly manager 122 may include machine learning to help identify the anomalous behavior in the application(s) 102. The anomaly manager 122 may manage multiple applications 102 at the same time. The anomaly manager 122 may manage different types of applications 102 in different communication devices 101. For example, the anomaly manager 122 may manage a security application 102 in a first communication device 101 and a word processing application 102 on a second communication device 101.

FIG. 1 also shows one or more applications 102 and an application manager 103 in the server 120. This is to illustrate that the applications 102/application manager 103 may reside in different places on the network 110 and/or be distributed on the network 110. For example, there may not be any applications 102/application manager 103 on the server 120 or there may not be any applications 102/application manager 103 on the communication devices 101.

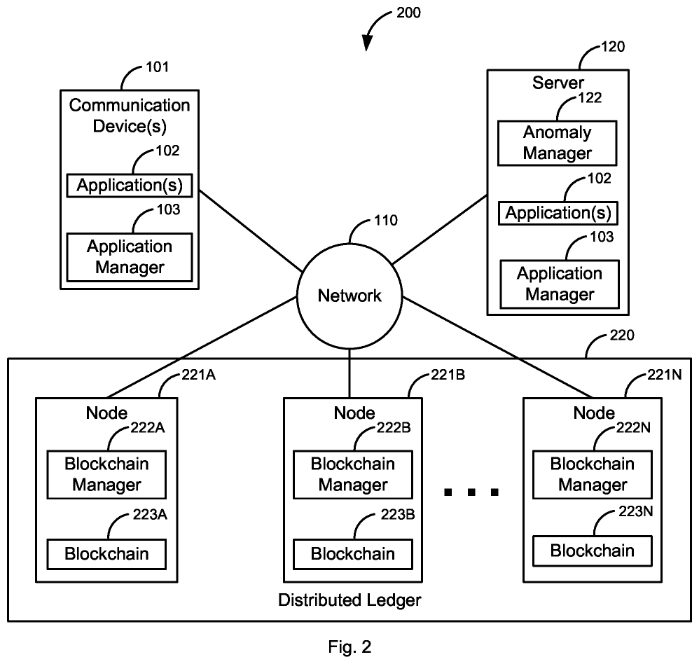

FIG. 2 is a block diagram of a second illustrative system 200 for tracking resources between load cycles of an application 102 using a distributed ledger 220/blockchain 223. The second illustrative system 200 comprises the communication device(s) 101, the network 110, the server 120, and a distributed ledger 220.

In FIG. 2, the communication device(s) 101 comprise the application(s) 102 and the application manager 103. The server 120 comprises the anomaly manager 122, the application(s) 102, and the application manager 103. The difference between FIG. 1 and FIG. 2 is that in FIG. 2 the database 121 has been replaced by the distributed ledger 220, which is a type of replicated database 121.

The distributed ledger 220 is used to store replicated copies of blockchains 223 on the nodes 221A-221N. The distributed ledger 220 is, in essence, a distributed database 121 where records are stored as blocks in the blockchains 223A-223N. The distributed ledger 220 comprises the nodes 221A-221N. The nodes 221A-221N may be on separate devices, containers, virtual machines, and/or the like. For example, the nodes 221A-221N may be separate servers 120 and/or communication devices 101. In one embodiment, the server 120 may be node 221 of the distributed ledger 220.

The nodes 1221A-221N comprise blockchain managers 222A-222N and blockchains 223A-223N. The blockchain managers 222A-222N manage the creation and copying of new blocks to the blockchains 223A-223N. The blockchain 223A-223N comprise blocks that are linked together based on hashes of previous blocks. The linking and hashing, along with the replicated structure make the blockchains 223A-223N highly immutable.

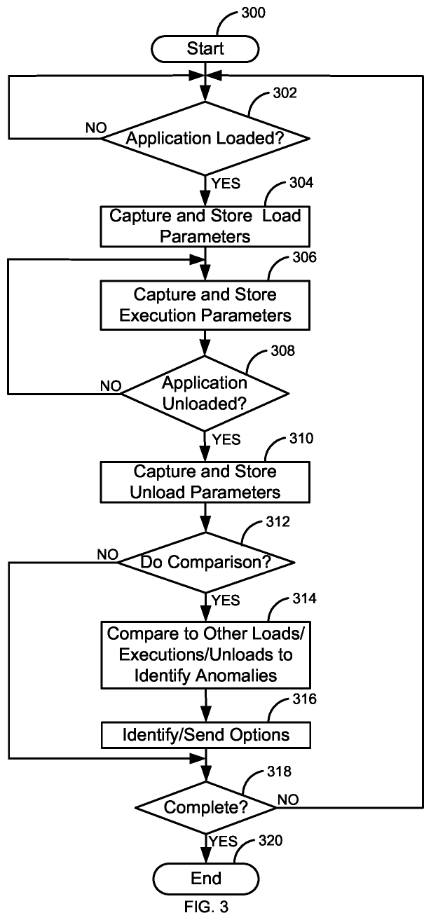

FIG. 3 is a flow diagram of a process for tracking resources between load cycles of an application 102. Illustratively, the communication device(s) 101, the application(s) 102, the application managers 103, the server 120, the database 121, the anomaly manager 122, the distributed ledger 220, the nodes 221A-221N, the blockchain managers 222A-222N, and the blockchains 223A-223N are stored-program-controlled entities, such as a computer or microprocessor, which performs the method of FIGS. 3-6 and the processes described herein by executing program instructions stored in a computer readable storage medium, such as a memory (i.e., a computer memory, a hard disk, and/or the like). Although the methods described in FIGS. 3-6 are shown in a specific order, one of skill in the art would recognize that the steps in FIGS. 3-6 may be implemented in different orders and/or be implemented in a multi-threaded environment. Moreover, various steps may be omitted or added based on implementation.

The process starts in step 300. The application manager 103 determines, in step 302, if the application 102 has been loaded. If the application 102 has not been loaded in step 302, the process of step 302 repeats. Otherwise, if the application 102 has been loaded, in step 302, the application manager 103 captures and stores load parameters associated with the application 102 in step 304. Load parameters can be any type of information associated with loading the application 102, such as, a hash of the application 102, a version of the application 102, a hash of a loader of the application 102, a version of the loader of the application 102, a hash of a hypervisor that loads the application 102 (e.g., the application 102 is in a container), a version of the hypervisor that loads the application 102, a hash of an operating system used by the application 102, a version of the operating system used by the application 102, a hash of a library (e.g., a Java class library, a dynamic linked library, etc.) used by the application 102, a version of the library used by the application 102, a hash of a configuration file used by the application 102, who loaded the application 102 (e.g., a user, an application 102, a thread, etc.), a time the application 102 was loaded, an initial memory allocation by the application 102, a location of one or more files (e.g., where they are stored in a file system) that are used by or are a part of the application 102, a size of the application 102, parameters provided when an application loads (e.g., command line parameters/arguments), a digital signature, and/or the like.

The load parameters can be stored in the database 121, in the distributed ledger 220/blockchain 223, and/or the like. For example, the application manager 103 may send the load parameters to the anomaly manager 122 to store in the database 121 and/or the distributed ledger 220/blockchain 223.

The application manager 103 captures and stores one or more execution parameters in step 306. An execution parameter may be any type of parameter associated with the execution of the application 102, such as, a number of containers spawned by the application 102, an amount of disk usage by the application 102, an amount of memory usage by the application 102, a number of user logins to the application 102, a number of user logouts from the application 102, a number of transactions executed by the application 102, a number of packets sent or received by the application 102, a number of function calls made by the application 102, a number of specific function calls made by the application 102, an amount of code usage by the application 102, a number of threads generated by the application 102, an order of threads generated by the application 102, an execution time of the application 102, an order of function calls made by the application 102, a size of one or more files used by the application 102, a number of permissions used by the application 102, a heap size, a stack size, and/or the like.

The execution parameters can be stored in the database 121, in the distributed ledger 220/blockchain 223, and/or the like. For example, the application manager 103 may send the execution parameters to the anomaly manager 122 to store in the database 121 and/or distributed ledger 220/blockchain 223.

The application manager 103 determines, in step 308, if the application 102 has been unloaded (i.e., the load cycle has completed). If the application 102 has not been unloaded in step 308, the process goes back to step 306 where the execution parameters are captured and stored. The execution parameters can be captured and stored in various ways, such as, based on a time period, based on a specific event (e.g., a number of logins, a number of packets sent etc.), and/or the like.

If the application 102 has been unloaded in step 308, the application manager 103 captures and stores unload parameters associated with the application 102 in step 310. For example, the unload parameters may comprise one or more of: a snapshot of activity of the application 102 just before the application 102 unloads, who unloaded the application 102 (e.g., a user, a thread, etc.), a time the application 102 was unloaded, an unload status (e.g., a successful unload, a unsuccessful unload (e.g., the application 102 crashed)), a fault location, and a number of current users of the application 102 when unloaded, and/or the like.

The unload parameters can be stored in the database 121, in the distributed ledger 220/blockchain 223, and/or the like. For example, the application manager 103 may send the unload parameters to the anomaly manager 122 to store in the database 121 and/or distributed ledger 220/blockchain 223.

The anomaly manager 122 determines if a comparison between load cycles of the application 102 is to be made in step 312. For example, if it is the first time the application 102 has been loaded, a comparison will not be made only a single load cycle has occurred. In addition, the comparison may be an administered parameter. If the comparison is not to be made in step 312, the process goes to step 318.

Otherwise, if a comparison is to be made in step 312, the anomaly manager 122 compares the load parameters, the execution parameters, and/or the unload parameters to a previous load cycle(s) to identify any potential anomalies in step 314. For example, if the memory usage and thread creation has dramatically changed from the previous load cycle(s) (load, execution, and unload), or the application 102 crashed, this may be identified as an anomaly. The anomaly may indicate malicious behavior and/or a misconfiguration.

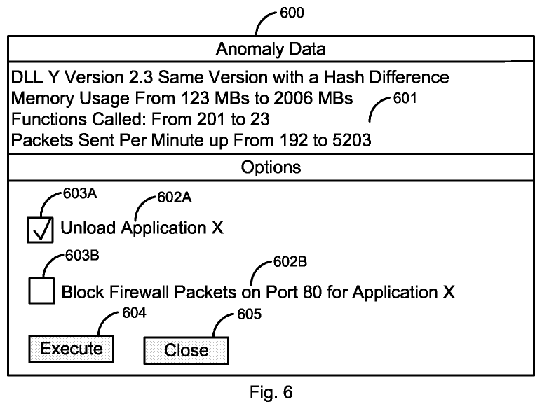

The anomaly manager 122 may identify potential options for a user in step 316. An option is an action to take to deal with the anomalous behavior. For example, if the anomaly indicates that the application 102 has likely been compromised by malware, an option may be to unload or not load the application 102. Instead of dealing with malicious activity, the action may be to fix a misconfiguration of the application on the network 110. The options can then be sent to a user where the user can select the one or more options as described in FIG. 6 to perform the options automatically.

Although FIG. 3 shows that the comparison is accomplished after unloading the application 102 in step 312. In one embodiment, the comparison may be done in real-time or semi-real-time (e.g., using a watchdog thread). For example, the comparison may be accomplished at load time (e.g., to determine whether to load the application 102) and/or during steps 306/308 (e.g., to determine whether to unload the application 102 in real-time) when the execution parameters are retrieved and stored.

The anomaly manager 122 determines in step 318 if the process is complete. If the process is not complete in step 318, the process goes back to step 312. Otherwise, if the process is complete in step 318, the process ends in step 320.

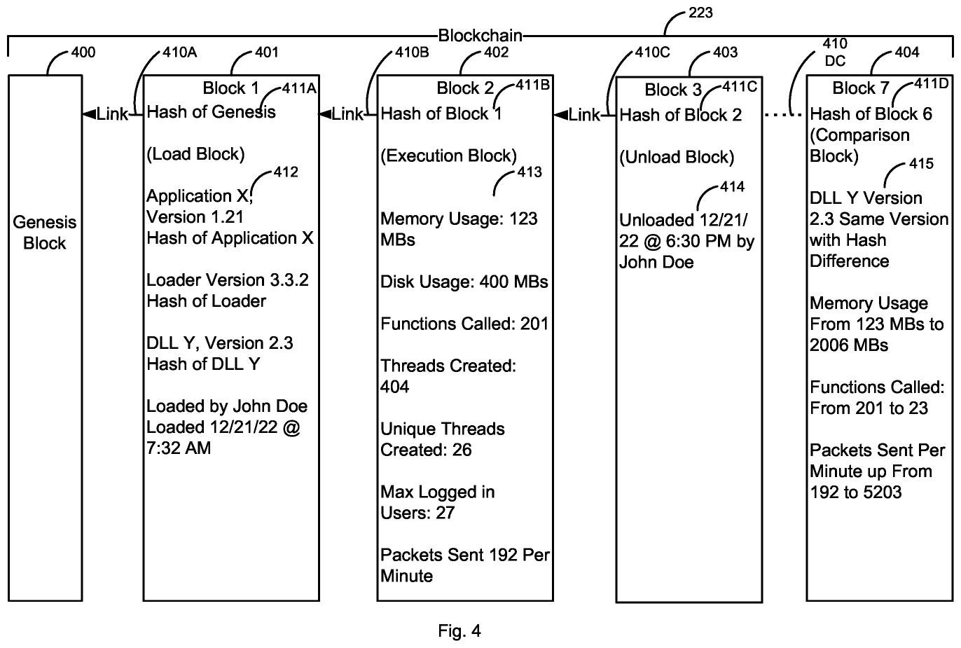

FIG. 4 is diagram of an exemplary blockchain 223 that is used to track resources between load cycles of an application 102. The blockchain 223 comprises a genesis block 400, a load block 401, an execution block 402, an unload block 403, and a comparison block 404. Although not shown for convenience, there is an additional load block 401, execution block 402, and unload block 403 between the unload block 403 and the comparison block 404.

The blocks 400-404 in the blockchain 223 are linked together by links 4010A-410D as is traditionally done in blockchains 223. The links 410A-410D point to the previous block. Each block (with the exception of the genesis block 400) has a hash of the previous block (hashes 411A-411D).

The genesis block 400 is created when the blockchain 223 is started. The load block 401 is created when the application 102 first loads. The load block 401 contains the load parameters 412. In this example, the load parameters comprises the version number of the application 102 (version 1.21), a hash of the application 102, a loader version (version 2.3.2), a hash of the loader, a Dynamically Liked Library (DLL Y) version, a hash of the DLL, who loaded the application 102 (John Doe), and when the application 102 was loaded (12/21/22@7:32 AM). Although not shown, any of the load parameters 412 described herein may be stored in the load block 401.

The execution block 402 further comprises the execution parameters 413. This includes a memory usage (123 MBs), a disk usage (400 MBs), a number of functions called (201), a number of threads created (404), a number of unique threads (26), a max number of users logged in (27), and a number of packets sent per minute (192). The execution block 402 may comprise multiple execution blocks 402. For example, the execution block 402 may be generated based on a time period, based on a specific event (e.g., a number of logins, a number of packets sent etc.), and/or the like. In one embodiment, the last execution block 402 (or the unload block 403) may comprise a snapshot of the executing application 102 just before the application 102 was unloaded.

The unload block 403 comprises the unload parameters 414. This includes a time that the application 102 was unloaded (12/21/22@6:30 PM) and who unloaded the application 102 (John Doe). The unload load block 403 may also include if the termination was normal or abnormal (e.g., if the executing application 102 crashed). If abnormal, the unload block 403 may include additional information associated with the abnormal unload, such as where the application 102 unloaded, etc. Although not shown in FIG. 4, the process is then repeated for the next load cycle where the application 102 is loaded, executed, and unloaded. A respective load block 401 (block 4), execution block(s) 402 (block 5), and unload block 403 (block 6) are created and stored in the blockchain 223.

The comparison block 404 is then created after the second load cycle. The comparison block 404 (Block 7) shows one or more variances (or none if there are not any). The variances may be from the previous load cycle or based on multiple previous load cycles. The variances may be learned over time based on machine learning or a user providing input (e.g., the user providing the thresholds). In FIG. 4, the variances are that the DLL Y version is the same, but now it has a different hash; in addition, memory usage went from 123 MBs to 2006 MBs, function calls were reduced from 201 to 23, and packets sent per minute increased from 192 per minute to 5023 per minute. The comparison block 404 provides a clear way to identify changes/anomalies that have occurred between load cycles of the application 102.

For example, when the DLL Y Version 2.3 hash changed on the second load/unload, the resources/behavior of the application 102 changed dramatically (memory usage increased, function calls decreased, and packets per minute increased). This may indicate that the DLL Y has been compromised by some form of malware.

In one embodiment, the comparison block 404 may have the comparison history between each of the previous comparison blocks 404. For example, if there are three comparison blocks 404, the last comparison block 404 will have a comparison back to each of the other two previous comparison blocks 404 (i.e., the last block will compare back to the first and second comparison blocks 404 individually). Alternatively, the comparison block 404 may show a comparison history between each of the previous comparison blocks 404. This could be used to identify trends. For example, if the comparison blocks 404 shows a similar increase in memory every time, this could indicate a slow start attack or a misconfiguration of a communication device 101 on the network 110.

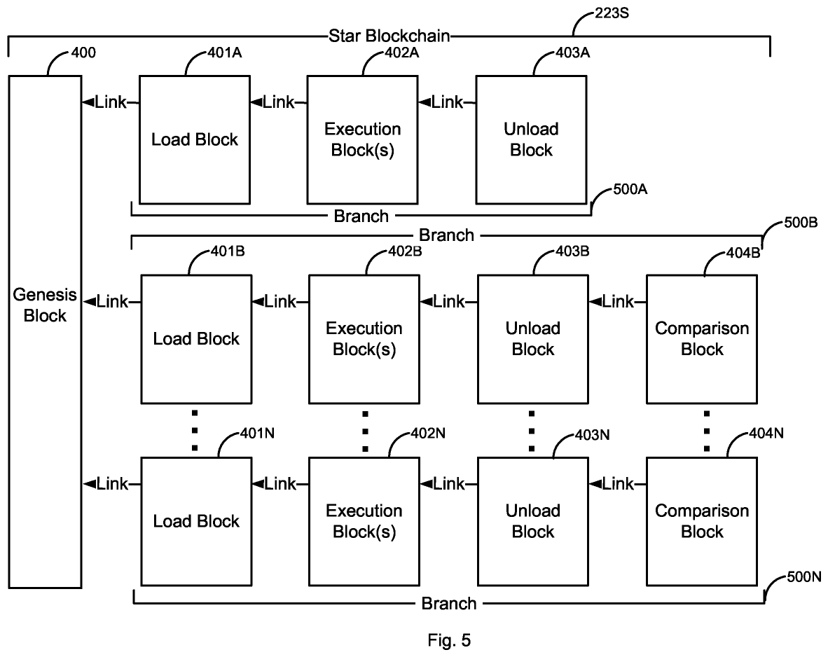

FIG. 5 is a diagram of an exemplary star blockchain 223S that is used to track resources between load cycles of an application 102. The star blockchain 223S comprises a genesis block 400 and branches 500A-500N. The branch 500A is the first branch 500 that is created when the application 102 is first loaded. The branch 500A comprises a load block 401A, an execution block 402A, and an unload block 403A (the first load cycle of the application 102). The branch 500B comprises a load block 401B, an execution block 402B, an unload block 403B, and a comparison block 404B (the second load cycle of the application 102). The branch 500N comprises a load block 401N, an execution block 402N, an unload block 403N, and a comparison block 404N (the Nth load cycle of the application 102).

For the star blockchain 223S, each time the application 102 loads, a new branch 500 is created off the genesis block 400. The branch 500 then ends when the application 102 is unloaded/terminated. For example, as shown in FIG. 5, the application 102 has been loaded N number of times, which results in the branches 500A-500N.

An advantage of the star blockchain 223S is that the process can easily compare similar blocks. For example, all the load blocks 401 will be the first block in each branch 500.

While the processes described in FIG. 4-5 discuss using a distributed ledger 220, the blockchain 223 may work without a distributed ledger 220. For example, a single blockchain 223 or a single linked list may be used in place of a traditional distributed ledger 220. In addition, any of the above embodiments may be employed for a container, a micro service, a virtual machine, and/or the like.

The process can be extended not only to comparing load cycles for the same application 102 on the same communication device 101, but also to comparing the load cycles for the same application 102 executed by different users of the same application 102 on different communication devices 101, containers, virtual machines, etc. For example, if there are 100 users that each use the application 102, the comparison may be extended to compare between the 100 users. In this example, comparing the comparison blocks 404 and/or the database records between different users are compared to identify anomalies between the different users. This can be used to identify trends of anomalies between multiple users. For example, if all the users have the same DLL hash issue as described above, this may identify an attack on multiple users on the network 110. On the other hand, if it is only a single user that shows the anomaly, then the single user may be the only one compromised.

In addition, the load, execute, and unload parameters can be used to track what versions of software all the users on the network 110 are using. Thus, the individual users may be asked to update their software (e.g., notify the user) or to automatically update any users that are not at the required version number for any files. In addition, the process may also identify if a software component has been corrupted and needs to be reloaded.

FIG. 6 is a diagram of an options window 600 that is used to take an action based on an anomalous behavior. The options window 600 comprises anomaly data 601, options 602A-602B, option check boxes 603A-603B, an execute button 604, and a close button 605.

The anomaly data 601 is based on variances in the load, execute, and unload parameters (e.g., parameters 412, 413, and 414). In this example, the anomaly data comprises load parameters (hash difference of DLL Y) and execute parameters (memory usage, functions called, and packets per minute). When the comparison block 404 is added (or when the anomaly data 601 is stored), a watchdog thread may be used to notify a user of the anomalous behavior. For example, the user may be notified based on a threshold or an approach to a threshold. Thus, the user can take the appropriate action. In this example, the user is provided a list of options to take. The options are to unload the application 102 (option 602A) and/or to block firewall packets on port 80 for the application 102 (option 602B). In this example, the user selects which options are wanted using the option check boxes 603A-603B and then clicks on the execute button 604. If the user does not want to execute any of the options, the user can just close the options window 600 using the close button 605.

The options presented to the user can be machine learned based on a previous history of users. For example, if a similar pattern has been seen where the user unloads the application 102 every time the memory usage goes above 200 MBs, the system can automatically determine that a potential option would be to give the user the option of unloading the application 102 if the memory usage goes over the 200 MBs threshold.

The process may be implemented where the user provides a list of options/threshold that are an input into the machine learning algorithm. The machine learning algorithm the uses the list of options as a basis of anomalies that are associated with the list of options. For example, some of the options may be to not load based the application 102 based on the last comparison block 404/database 121, block increases in memory, block access to a specific resource/system, block access to ABC system, disable a port number, and/or the like. The system can identify specific users and/or groups of users who are notified. The system may also identify who of those users are currently active so someone can be identified and notified in real-time.

In one embodiment, each of the comparison blocks 404 and/or variances may be used as an input into the machine learning process. This could be extended into the cloud environment, where it is provided as a service for different tenants.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
determine that a first load cycle of an application has been completed.
retrieve one or more of: a first load parameter associated with the first load cycle of the application, a first execution parameter associated with the first load cycle of the application, and a first unload parameter associated with the first load cycle of the application; and
compare one or more of the following to identify an anomalous behavior of the application:
the first load parameter associated with the first load cycle of the application and a second load parameter associated with a second load cycle of the application;
the first execution parameter associated with the first load cycle of the application and a second execution parameter associated with the second load cycle of the application; and
the first unload parameter associated with the first load cycle of the application and a second unload parameter associated with the second load cycle of the application.

2. The system of claim 1, wherein first load parameter associated with the first load cycle of the application comprises one or more of: a hash of the application, a version of the application, a hash of a loader of the application, a version of the loader of the application, a hash of a hypervisor that loads the application, a version of the hypervisor that loads the application, a hash of an operating system used by the application, a version of the operating system used by the application, a hash of a library used by the application, a version of the library used by the application, a hash of a configuration file used by the application, who loaded the application, a time the application was loaded, an initial memory allocation by the application, a location of one or more files that are used by or are a part of the application, command line parameters provided when an application is loaded, a digital signature, and a size of the application.

3. The system of claim 1, wherein the first execution parameter associated with the first load cycle of the application comprises one or more of: a number of containers spawned by the application, an amount of disk usage by the application, an amount of memory usage by the application, a number of user logins to the application, a number of user logouts from the application, a number of transactions executed by the application, a number of packets sent by the application, a number of packets received by the application, a number of function calls made by the application, a number of specific function calls made by the application, an amount of code usage by the application, a number of threads generated by the application, an order of threads generated by the application, an execution time of the application, an order of function calls made by the application, a size of one or more files used by the application, a heap size, a stack size, and a number of permissions used by the application.

4. The system of claim 1, wherein the first unload parameter associated with the first load cycle of the application comprises one or more of: a snapshot of activity of the application just before the application unloads, who unloaded the application, a time the application was unloaded, an unload status, a fault location, a number of current users of the application when unloaded, and information about the current number of users when the application is unloaded.

5. The system of claim 1, wherein the second load parameter associated with the second load cycle of the application, the second execution parameter associated with the second load cycle of the application, and the second unload parameter associated with the second load cycle of the application are from a load cycle of the application on a different device.

6. The system of claim 1, wherein the parameters are stored in a blockchain.

7. The system of claim 6, wherein the blockchain is a star blockchain that has a branch for each load cycle of the application.

8. The system of claim 7, wherein the star blockchain has a comparison block after each branch in the star blockchain except the first branch in the star blockchain.

9. The system of claim 6, wherein the blockchain comprises a comparison block that identifies one or more variances between the first load cycle of the application and the second load cycle of the application.

10. The system of claim 9, wherein the comparison block has history between each of a number of previous comparison blocks and/or a comparison between each of the number of previous comparison blocks.

11. The system of claim 1, wherein the microprocessor readable and executable instructions further cause the microprocessor to:
create a watchdog thread, wherein the watchdog thread uses the comparison to determine whether to load and/or unload the application.

12. The system of claim 1, wherein the microprocessor readable and executable instructions further cause the microprocessor to:
identify one or more options associated with the anomalous behavior; and
generate, for display to a user, the one or more options associated with the anomalous behavior.

13. A method comprising:
determining, by a microprocessor, that a first load cycle of an application has been completed.
retrieving, by the microprocessor, one or more of: a first load parameter associated with the first load cycle of the application, a first execution parameter associated with the first load cycle of the application, and a first unload parameter associated with the first load cycle of the application; and
comparing, by the microprocessor, one or more of the following to identify an anomalous behavior of the application:
the first load parameter associated with the first load cycle of the application and a second load parameter associated with a second load cycle of the application;
the first execution parameter associated with the first load cycle of the application and a second execution parameter associated with the second load cycle of the application; and
the first unload parameter associated with the first load cycle of the application and a second unload parameter associated with the second load cycle of the application.

14. The method of claim 13, wherein first load parameter associated with the first load cycle of the application comprises one or more of: a hash of the application, a version of the application, a hash of a loader of the application, a version of the loader of the application, a hash of a hypervisor that loads the application, a version of the hypervisor that loads the application, a hash of an operating system used by the application, a version of the operating system used by the application, a hash of a library used by the application, a version of the library used by the application, a hash of a configuration file used by the application, who loaded the application, a time the application was loaded, an initial memory allocation by the application, a location of one or more files that are used by or are a part of the application, command line parameters provided when an application is loaded, a digital signature, and a size of the application.

15. The method of claim 13, wherein the first execution parameter associated with the first load cycle of the application comprises one or more of: a number of containers spawned by the application, an amount of disk usage by the application, an amount of memory usage by the application, a number of user logins to the application, a number of user logouts from the application, a number of transactions executed by the application, a number of packets sent by the application, a number of packets received by the application, a number of function calls made by the application, a number of specific function calls made by the application, an amount of code usage by the application, a number of threads generated by the application, an order of threads generated by the application, an execution time of the application, an order of function calls made by the application, a size of one or more files used by the application, a heap size, a stack size, and a number of permissions used by the application.

16. The method of claim 13, wherein the first unload parameter associated with the first load cycle of the application comprises one or more of: a snapshot of activity of the application just before the application unloads, who unloaded the application, a time the application was unloaded, an unload status, a fault location, and a number of current users of the application when unloaded.

17. The method of claim 13, wherein the compared parameters are stored in a blockchain.

18. The method of claim 17, wherein the blockchain is a star blockchain that has a branch for each load cycle of the application.

19. The method of claim 17, wherein the blockchain comprises a comparison block that identifies one or more variances between the first load cycle of the application and the second load cycle of the application.

20. A non-transient computer readable medium having stored thereon instructions that cause a processor to execute a method, the method comprising:
instructions to:
determine that a first load cycle of an application has been completed.
retrieve one or more of: a first load parameter associated with the first load cycle of the application, a first execution parameter associated with the first load cycle of the application, and a first unload parameter associated with the first load cycle of the application; and
compare one or more of the following to identify an anomalous behavior of the application:
the first load parameter associated with the first load cycle of the application and a second load parameter associated with a second load cycle of the application;
the first execution parameter associated with the first load cycle of the application and a second execution parameter associated with the second load cycle of the application; and
the first unload parameter associated with the first load cycle of the application and a second unload parameter associated with the second load cycle of the application.
